(19) United States
(12) Patent Application Publication
(10) Pub. No.: US 2011/0135252 A1
(43) Pub. Date: Jun. 9, 2011

(54) SILICON PHOTONICS CHIP

(75) Inventors: Do Won KIM, Daejeon (KR); Gyungock Kim, Seoul (KR); Junghyung Pyo, Seoul (KR); Duk Jun Kim, Daejeon (KR); In Gyoo Kim, Daejeon (KR)

(73) Assignee: Electronics and Telecommunications Research Institute, Daejeon (KR)

(21) Appl. No.: 12/816,323

(22) Filed: Jun. 15, 2010

(30) Foreign Application Priority Data
Dec. 8, 2009 (KR) 10-2009-0121080

(51) Int. Cl. G02B 6/30; G02B 6/10

(52) U.S. Cl. 385/49; 385/130; 385/52; 385/88

(57) ABSTRACT

Provided is a silicon photonics chip that is thermally separated from a light emitting device. The silicon photonics chip includes photoelectric devices integrated on a silicon substrate. The photoelectric devices include an optical connection device optically guiding at least one signal light incident from a signal light generation device to transmit the signal light into the silicon substrate. The signal light generation device is thermally separated from the photoelectric devices, and is optically connected to the photoelectric devices.

### CROSS-REFERENCE TO RELATED APPLICATIONS

This U.S. non-provisional patent application claims priority under 35 U.S.C. §119 of Korean Patent Application No. 10-2009-0121080, filed on Dec. 8, 2009, the entire contents of which are hereby incorporated by reference.

### BACKGROUND OF THE INVENTION

The present invention disclosed herein relates to a photonics device, and more particularly, to a silicon photonics chip.

Information transmitting and processing technology using light (hereinafter, referred to as photonics) may be embodied using photonics devices such as light emitting devices, light receiving devices, optical waveguides, modulators, multiplexers (MUXs), and demultiplexers (DEMUXs), and research has been actively carried out on photonics since a large amount of data can be transmitted at high speed using photonics. Specifically, in recent years, research for integrating photonics devices on a single chip is being actively carried out, and various remarkable results have been reported. For example, according to recent silicon photonics technologies, photonics devices can be formed on a silicon substrate to which a silicon semiconductor technology can be applied. Thus, most photonics chips can be integrated with silicon-based electronic devices on a single silicon chip.

When photonics chips are monolithically integrated on a silicon substrate, the size and weight of a product can be reduced, and its integration and reliability can be improved. Moreover, since such single integrated products can be fabricated through massive production, costs of the product can be reduced. However, unlike other photonics devices, forming of light sources or light emitting devices with silicon material may be difficult. For example, since heat generated while a light source or light emitting device generates light may change physical and optical characteristics of a product, when the product is used for a long time, its durability and stability may not be guaranteed. Moreover, since silicon is one of indirect bandgap materials causing various technical limitations, it is known to be inappropriate for light sources or light emitting devices.

### SUMMARY OF THE INVENTION

The present invention provides a silicon photonics chip capable of improving efficiency in optically connecting to a light source.

The present invention also provides a silicon photonics chip having improved durability and stability.

Embodiments of the present invention provide silicon photonics chips that are thermally separated from light emitting devices. The silicon photonics chips include photoelectric devices integrated on a silicon substrate. The photoelectric devices include an optical connection device optically guiding at least one signal light incident from a signal light generation device. The signal light generation device is thermally separated from the photoelectric devices, and is optically connected to the photoelectric devices.

In some embodiments, the silicon photonics chips may further include an internal ferrule including at least one internal optical fiber and optically aligned with the optical connection device, wherein the internal ferrule is optically aligned with an external ferrule guiding the signal light incident from the signal light generation device.

In other embodiments, the external ferrule may include at least one external optical fiber providing an optical connection passage between the signal light generation device and the silicon photonics chip, and an external engagement element physically connecting the external ferrule to the internal ferrule, and the internal ferrule may include an internal engagement element that is physically and fittingly engaged with the external engagement element to optically align the internal optical fiber with the external optical fiber.

In still other embodiments, the internal ferrule may form a slanted angle ranging from about 1° to about 20° with a normal line to an upper surface of the silicon substrate. The internal optical fiber may be a core expansion optical fiber or a lensed fiber.

In even other embodiments, the optical connection device may include a grating coupler disposed on the silicon substrate.

In yet other embodiments, the silicon substrate may include a silicon pattern defining a groove region, and a waveguide disposed in the groove region and extending to one of the photoelectric devices. The silicon pattern may include a side wall slanted from an upper surface of the silicon substrate. The slanted side wall of the silicon pattern may be used as the optical connection device guiding the signal light to the waveguide. The silicon photonics chips may further include a thermal control member thermally separating the signal light generation device from the photoelectric devices.

In further embodiments, the silicon substrate may include a groove region, and the signal light generation device may be disposed in the groove region. The silicon photonics chips may further include a thermal control member thermally separating the signal light generation device from the photoelectric devices. The silicon photonics chips may further include a waveguide disposed on the silicon substrate and extending to one of the photoelectric devices. An end of the waveguide adjacent to the signal light generation device may guide the signal light to one of the photoelectric devices.

In still further embodiments, the photoelectric devices may include an optical waveguide, a modulator, a multiplexer (MUX), and a demultiplexer (DEMUX), and a light receiving device. The modulator may use an electrical method to vary an optical characteristic of at least one signal light incident from the optical connection device.

In even further embodiments, the silicon photonics chips may further include an internal ferrule including at least one internal optical fiber and optically aligned with the optical connection device, wherein the signal light generation device is packaged on the internal ferrule through a flexible printed circuit board including conductive interconnections, and is optically aligned with the internal optical fiber. The signal light generation device may vary an optical characteristic of the signal light in response to electric signals applied through the conductive interconnections.

In yet further embodiments, the silicon photonics chips may further include a printed circuit board disposed at a lower portion of the silicon substrate and electrically connected to the photoelectric devices, and a passivation member disposed at an upper portion of the silicon substrate, covering the photoelectric devices, and exposing an internal ferrule, wherein the passivation member is adhered to a side wall of the internal ferrule through an adhesive member, and fixed to the printed circuit board through a fixing member. An upper surface of the passivation member may be higher than an upper surface of the internal ferrule.

In much further embodiments, the signal light generation device is attached onto the silicon substrate, and a thermal control member may be disposed between the signal light generation device and the silicon substrate. The optical connection device may include a microlens disposed between the signal light generation device and the photoelectric devices.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a schematic view illustrating a silicon photonics chip according to an embodiment of the present invention;

FIG. 2 is a perspective view illustrating the silicon photonics chip according to an embodiment of the present invention;

FIGS. 3 and 4 are perspective views illustrating a packaged silicon photonics chip according to an embodiment of the present invention;

FIG. 5 is a cross-sectional view illustrating the packaged silicon photonics chip according to an embodiment of the present invention in more detail;

FIGS. 6 and 7 are schematic views illustrating optical connection devices according to embodiments of the present invention;

FIGS. 8A and 8B are cross-sectional views illustrating core structures of optical fibers according to embodiments of the present invention;

FIGS. 9A through 9D are perspective views illustrating end-portions of optical fibers according to embodiments of the present invention;

FIG. 10 is a schematic view illustrating a silicon photonics chip according to another embodiment of the present invention;

FIG. 11 is a perspective view illustrating a packaged silicon photonics chip according to another embodiment of the present invention;

FIG. 12 is a cross-sectional view illustrating a silicon photonics chip according to other embodiment of the present invention; and

FIGS. 13 and 14 are a perspective view and a cross-sectional view illustrating a silicon photonics chip according to a modified embodiment of the present invention, respectively.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, it will be understood that when an element such as a layer, film, region, or substrate is referred to as being “on” another element, it can be directly on the other element or intervening elements may also be present. In the figures, the dimensions of layers and regions are exaggerated for clarity of illustration. Also, though terms like a first, a second, and a third are used to describe various regions and layers in various embodiments of the present invention, the regions and the layers are not limited to these terms. These terms are used only to discriminate one region or layer from another region or layer. Therefore, a layer referred to as a first layer in one embodiment can be referred to as a second layer in another embodiment. An embodiment described and exemplified herein includes a complementary embodiment thereof.

Hereinafter, it will be described about exemplary embodiments of the present invention in conjunction with the accompanying drawings.

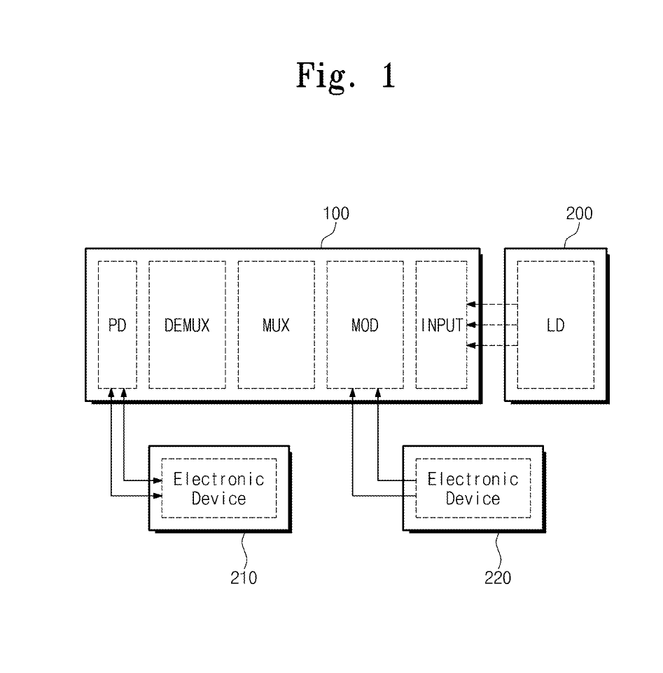

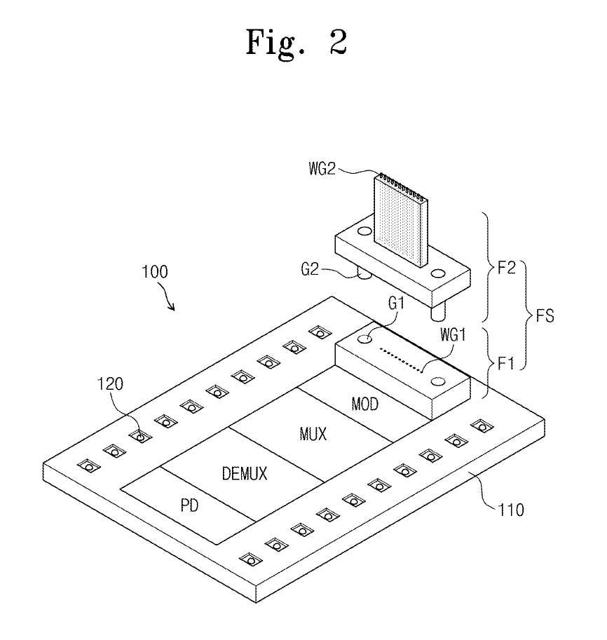

FIG. 1 is a schematic view illustrating a silicon photonics chip according to an embodiment of the present invention. FIG. 2 is a perspective view illustrating the silicon photonics chip of FIG. 2.

Referring to FIG. 1, a silicon photonics chip 100 may include a plurality of photoelectric devices that process light (hereinafter, referred to as incident light) incident from a light emitting device 200. The photoelectric devices may include an optical connection device INPUT, a modulation device MOD, a multiplexer MUX, a demultiplexer DEMUR, and a light receiving device PD. The photoelectric devices may be optically connected to each other through an optical waveguide disposed on the silicon photonics chip 100.

The light receiving device PD may be a photoelectric device converting an optical signal to an electric signal, e.g., be a photodiode. The light receiving device PD may be configured to be capable of communicating electrically with a first electronic device 210. The modulation device MOD may be configured to vary optical characteristics of the incident light in response to an electric signal. To this end, the modulation device MOD may be connected to a second electronic device 220. According to an embodiment, the first and second electronic devices 210 and 220 may be disposed outside the silicon photonics chip 100. Alternatively, according to another embodiment, the first and second electronic devices 210 may be integrated on a silicon substrate with the photoelectric devices constituting the silicon photonics chip 100.

The light emitting device 200 may be a laser generation device LD that generates a laser beam. A laser beam generated by the laser generation device LD, i.e., the incident light, may be incident to the optical connection device INPUT. The optical connection device INPUT may be configured to transmit the incident light to other photoelectric devices. The light emitting device 200 is optically connected to the silicon photonics chip 100 through the optical connection device INPUT. Alternatively, according to the spirit of the present invention, the light emitting device 200 may be thermally separated from the silicon photonics chip 100. For example, the light emitting device 200 may be thermally distant from the silicon photonics chip 100, which will be described later with reference to FIGS. 2 through 4.

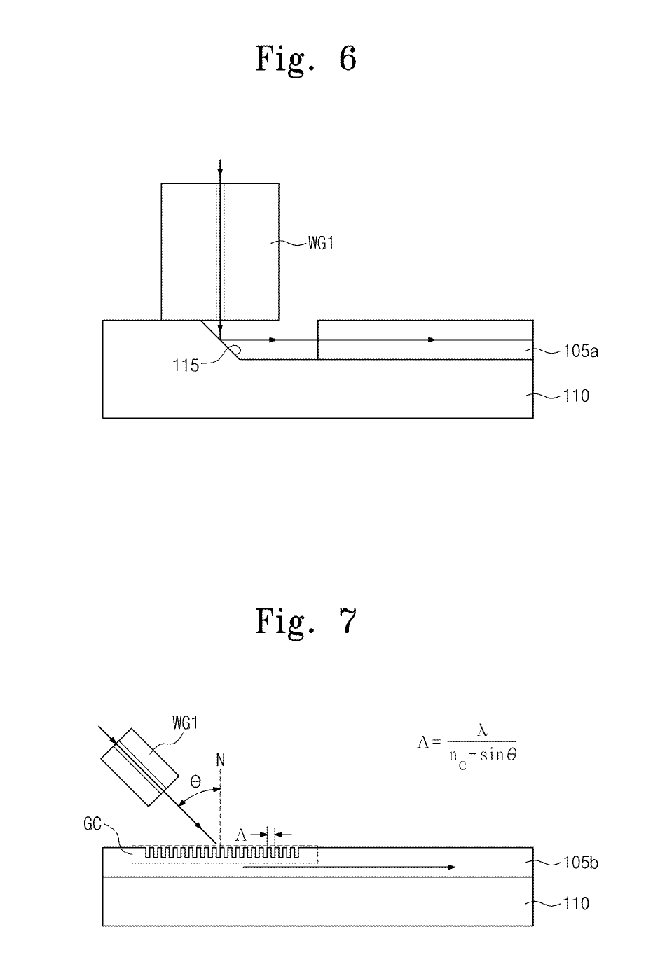

Referring to FIG. 2, the silicon photonics chip 100 may include a silicon substrate 110 and a ferrule structure FS. The photoelectric devices INPUT, MOD, MUX, DEMUX, and PC as illustrated in FIG. 1 may be integrated on the silicon substrate 110 through a well-known semiconductor fabricating process. According to the current embodiment, an internal ferrule F1, as a part of the optical connection device INPUT, may be disposed on the silicon substrate 110. Optical guide elements, as another part of the optical connection device INPUT, may be disposed under the internal ferrule F1 to transmit light from the light emitting device 200 to the photoelectric devices. The optical guide elements will be described later in more detail with reference to FIGS. 6 and 7.

The internal ferrule F1 may be physically and optically aligned with an external ferrule F2. To this end, the internal ferrule F1 may include an internal guiding portion G1 and at least one internal optical fiber WG1, the external ferrule F2 may include an external guiding portion G2 and at least one external optical fiber WG2. The internal guiding portion G1 and the external guiding portion G2 may be physically and fittingly engaged with each other. For example, as illustrated in FIG. 2, the external guiding portion G2 may include one or more guide pins protruding outward, and the internal guide portion G1 may include one or more guide pin holes recessed inward. Alternatively, according to another embodiment, the external guiding portion G2 may include one or more guide pin holes, and the internal guide portion G1 may include one or more guide pins. As such, when guide pins and guide pin holes are used as an engagement element, a fabricating process can be simplified to reduce fabricating costs, optical connection efficiency can be increased, and optical connection can be facilitated.

The external optical fiber WG2 and the internal optical fiber WG1 may be configured to transmit sequentially laser beams from the outside of the silicon photonics chip 100 to the photoelectric devices. To this end, the external optical fiber WG2 may extend to the light emitting device 200.

The internal ferrule F1 may have at least one through hole into which the internal optical fiber WG1 may be inserted. The internal ferrule F1 is bonded to the silicon substrate 110 such that the internal optical fiber WG1 is optically aligned with the optical guide elements. The internal ferrule F1 may be bonded to the silicon substrate 110 through predetermined adhesive. According to an embodiment, the adhesive may be one of high molecular epoxy resin adhesives whose refractive index are similar with the internal optical fiber WG1 and the external optical fiber WG2. In this case, reflection loss at the interfaces between the adhesive, the internal optical fiber WG1, and the external optical fiber WG2 may be reduced, thus inhibiting optical loss. Moreover, the internal ferrule F1 may be bonded to the silicon substrate 110 such that the internal ferrule F1 forms an angle ranging from about 1° to about 20° with a normal line to the upper surface of the silicon substrate 110, so as to inhibit the reflection loss.

The silicon photonics chip 100 may include predetermined electronic devices (e.g., the first and second electronic devices 210) disposed on the silicon substrate 110, and conductive pads 120 electrically connected to the electronic devices.

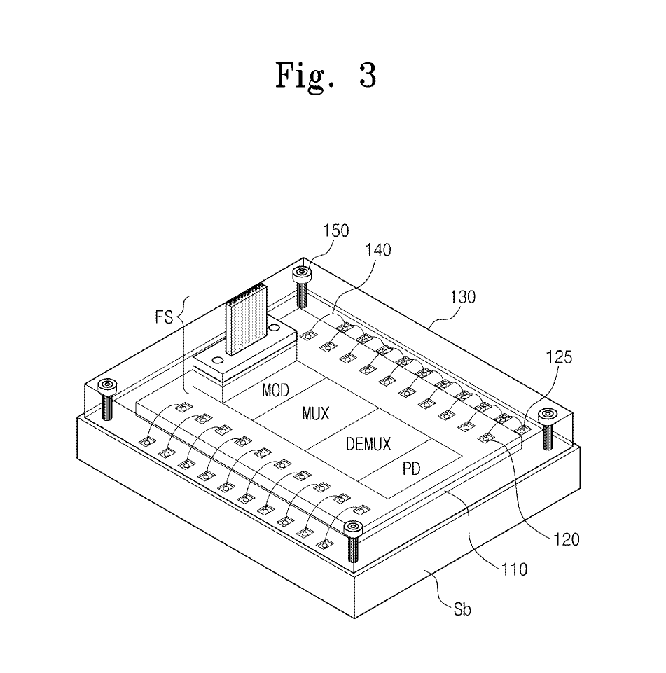

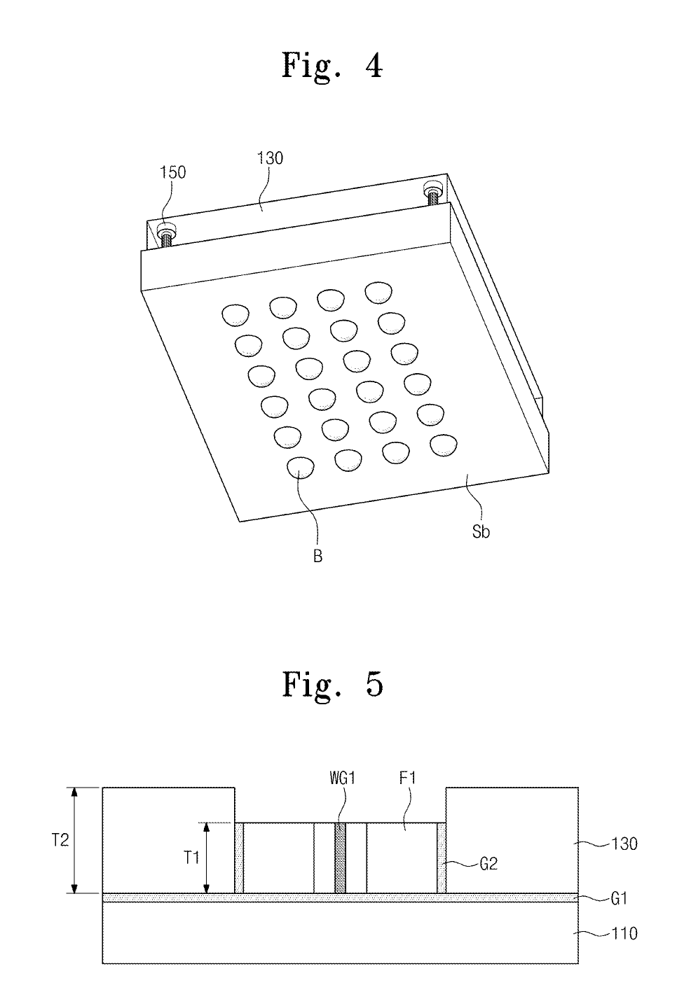

FIGS. 3 and 4 are perspective views illustrating a state where the silicon photonics chip of FIG. 1 is packaged. The same part as those described with reference to FIG. 2 may be omitted. FIG. 5 is a cross-sectional view illustrating the packaged silicon photonics chip of FIG. 3 in more detail.

Referring to FIGS. 3 and 4, a printed circuit board Sb may be disposed at the lower portion of the silicon substrate 110, and a passivation member 130 covering the photoelectric devices may be disposed at the upper portion of the silicon substrate 110.

The printed circuit board Sb may be configured to transmit electric signals between the printed circuit board Sb and the silicon photonics chip 100 or other external electronic devices. For example, the printed circuit board Sb may include bonding pads 125 connected electrically to the silicon photonics chip 100 and solder balls B for electrically connecting to external electronic devices, but the present invention is not limited thereto. The bonding pads 125 may be electrically connected to the conductive pads 120 through conductive wires 140.

The passivation member 130 may cover the silicon substrate 110, the conductive wires 140, the bonding pads 125, and the conductive pads 120, and have an opening exposing the internal ferrule F1. Referring to FIG. 5, the upper surface of the passivation member 130 may be higher than the upper surface of the internal ferrule F1. In this case, when the guide pins and guide pin holes are used as an engagement element, the external ferrule F2 may be supported through the opening of the passivation member 130. Thus, the external ferrule F2 can be coupled to the internal ferrule F1 more stably. Moreover, as illustrated in FIG. 5, the passivation member 130 may be adhered to a side wall of the internal ferrule F1 and the silicon substrate 110 through predetermined adhesive members G1 and G2. In this case, durability of the ferrule structure FS and accuracy of the optical connection can be effectively secured.

According to an embodiment, the passivation member 130 may be fixed to the printed circuit board Sb through a predetermined fixing member. The fixing member may be a bolt-nut structure as illustrated in FIGS. 3 and 4, or be adhesive.

FIGS. 6 and 7 are schematic views illustrating optical connection devices according to embodiments of the present invention.

Referring to FIG. 6, a groove region defining a slanted side wall 115 is disposed in a predetermined region of the silicon substrate 110, and a first optical waveguide 105a extending to the photoelectric devices may be disposed on the groove region. According to the current embodiment, the internal ferrule F1 may guide the incident light to the slanted side wall 115. Since the slanted side wall 115 may be optically used as a reflective surface, the slanted side wall 115 may reflect the incident light to the first optical waveguide 105a, so that the incident light can be transmitted to the photoelectric devices.

According to an embodiment of the present invention, the light emitting device 200 may be bonded to the silicon substrate 110 using a flip-chip bonding technology. In this case, light emitted from the light emitting device 200 may be directly incident to the slant side wall 115 without using the internal ferrule F1 or the external ferrule F2.

Referring to FIG. 7, patterns constituting a grating coupler GC, and a second optical waveguide 105b adjacent to the patterns may be disposed in a predetermined region of the silicon substrate 110.

According to the current embodiment, the internal ferrule F1 may transmit the incident light to the grating coupler GC in the state where the light forms a predetermined incident angle θ with a normal line N to the upper surface of the silicon substrate 110. At this point, the relationship between a pitch of the patterns and the incident angle θ may be expressed by an equation shown in FIG. 7. Thus, when an incident angle of the incident light is adjusted, the incident light may be transmitted to the photoelectric devices through the second optical waveguide 105b.

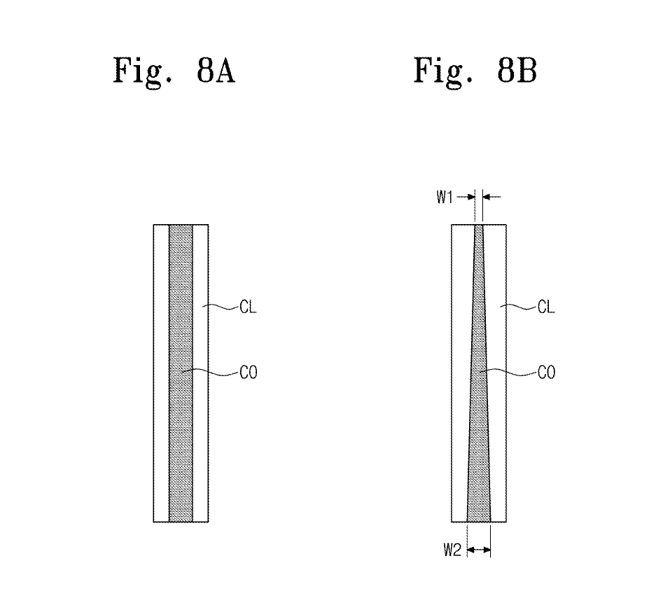

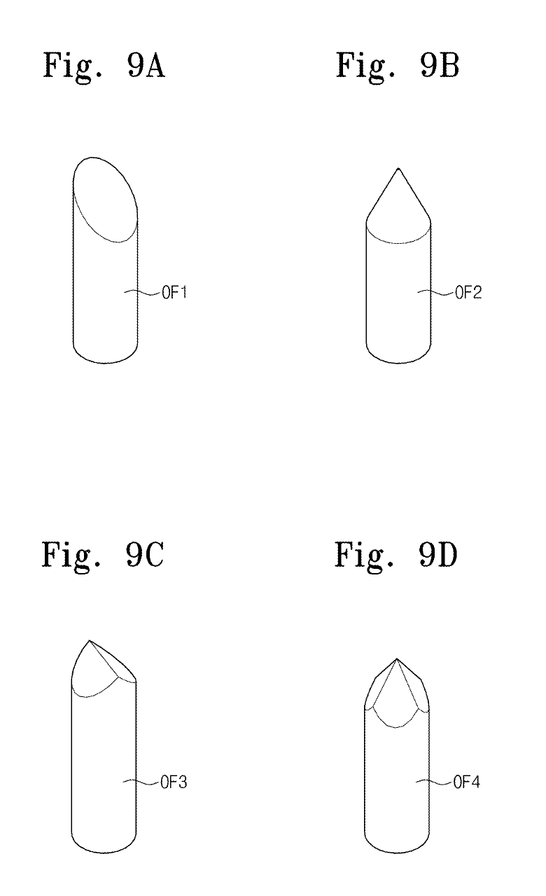

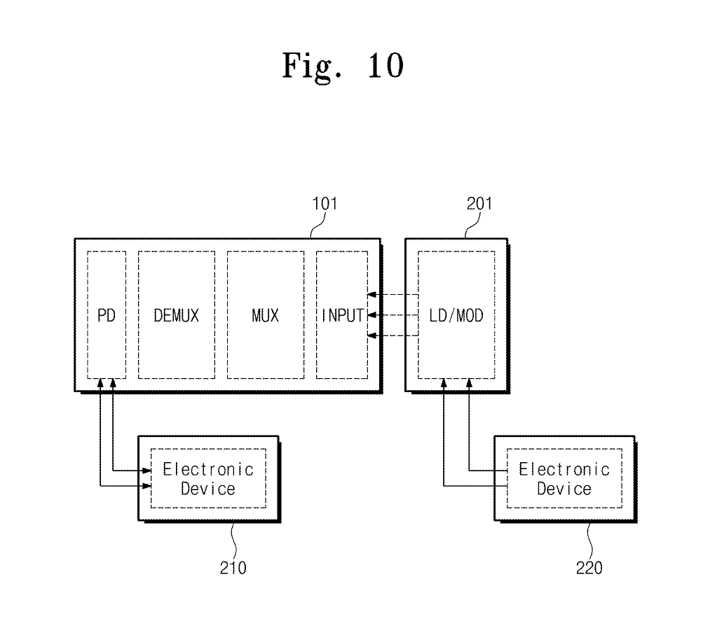

FIGS. 8A and 8B are cross-sectional views illustrating core structures of optical fibers according to embodiments of the present invention. FIGS. 9A through 9D are perspective views illustrating ends of optical fibers according to embodiments of the present invention.

Referring to FIG. 8A, an optical fiber having a core (CO) with a uniform diameter may be used as the internal optical fiber WG1 or the external optical fiber WG2. Referring to FIG. 8B, a core expansion optical fiber may be used as the internal optical fiber WG1. In this case, the core (CO) of the core expansion optical fiber has a diameter that is gradually increased using a thermal method, that is, a diameter W2 is greater than a diameter W1. Accordingly, optical loss in the optical interconnection can be reduced, and the optical connection efficiency can be improved.

Moreover, according to modified embodiments of the present invention, the internal optical fiber WG1 or the external optical fiber WG2 may be one of various lensed fibers such as an angle polished fiber (OF1), a conical fiber (OF2), a wedged fiber (OF3), and a tapered fiber (OF4), illustrated in FIGS. 9A through 9D respectively.

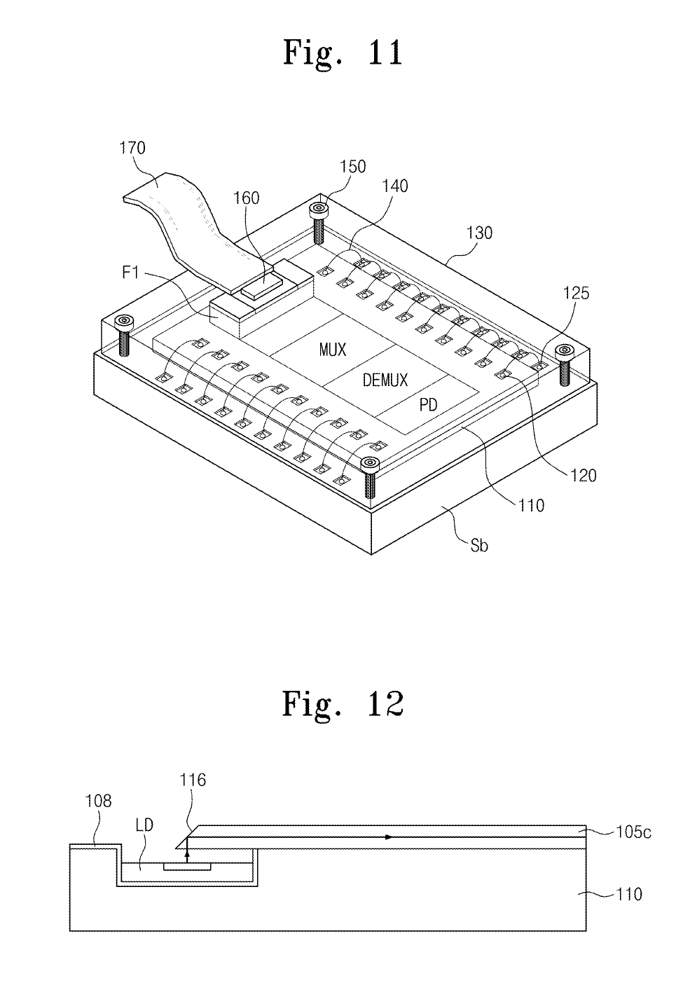

FIG. 10 is a schematic view illustrating a silicon photonics chip according to another embodiment of the present invention. FIG. 11 is a perspective view illustrating a state where the silicon photonics chip of FIG. 10 is packaged. The same parts of the embodiment of FIGS. 10 and 11 as those of the embodiments described with reference to FIGS. 1 through 9 may be omitted.

Referring to FIG. 10, a silicon photonics chip 101 may include a plurality of photoelectric devices that process light (hereinafter, referred to as incident light) incident from a light emitting device 201. The photoelectric devices may include the optical connection device INPUT, the multiplexer MUX, the demultiplexer DEMUX, and the light receiving device PD.

According to the current embodiment, the light emitting device 201 may be provided in package form to the upper portion of the internal ferrule F1. For example, referring to FIG. 11, the external ferrule F2 may be optically aligned with the internal ferrule F1. A laser device 160 used as the light emitting device 201 and conductive interconnections 170 for electrically controlling the laser device 160 are attached to the external ferrule F2. According to a modification of the current embodiment, the laser device 160 and the conductive interconnections 170 may be directly attached onto the internal ferrule F1, and a fixing member (not shown) may be disposed on the upper portions of the laser device 160 and the conductive interconnections 170 to fix the laser device 160 and the conductive interconnections 170 to the internal ferrule F1.

The conductive interconnections 170 may be electrically connected to the second electronic device 220, and be used as a passage for transmitting electric power generating the incident light, or a passage for transmitting electric signals to vary the optical characteristics of the incident light. In this case, the second electronic device 220 connected with the conductive interconnections 170 may be integrated with the photoelectric devices on the silicon substrate 110, or be provided as a discrete external chip. The conductive interconnections 170 may include a line formed of metal such as copper having ductility, and a flexible sheathe surrounding the line. In this case, the conductive interconnections 170 may have even higher flexibility than the external optical fiber WG2 does, thus increasing the degree of freedom in electrically connecting to the second electronic device 220. According to an embodiment, the conductive interconnections 170 may be formed in a flexible printed circuit board (PCB).

According to the current embodiment, the spatial distance between the light emitting device 201 and the photoelectric devices of the silicon photonics chip 101 is less than that of the embodiment described with reference to FIGS. 1 through 5. However, due to the presence of the internal ferrule F1, the light emitting device 201 is still thermally separated from the silicon photonics chip 101.

FIG. 12 is a cross-sectional view illustrating a silicon photonics chip according to another embodiment of the present invention. The same parts of the current embodiment as those of the embodiments described with reference to FIGS. 1 through 11 may be omitted.

According to the current embodiment, a light emitting device LD generating the incident light may be inserted in the silicon substrate 110. A third optical waveguide 105c may be disposed on the upper portion of the light emitting device LD to change a travelling path of the incident light. For example, referring to FIG. 12, the third optical waveguide 105c may have an end disposed on an emitting path of the incident light, and the end may have a slanted facet 116 to change a travelling path of the incident light.

Moreover, according to the current embodiment, a predetermined thermal control member 108 may be disposed between the light emitting device LD and the silicon substrate 110 to thermally separate the light emitting device LD from the silicon substrate 110. For example, the thermal control member 108 may be a heat insulating member, a cooling member having high heat conductivity, or a Peltier element.

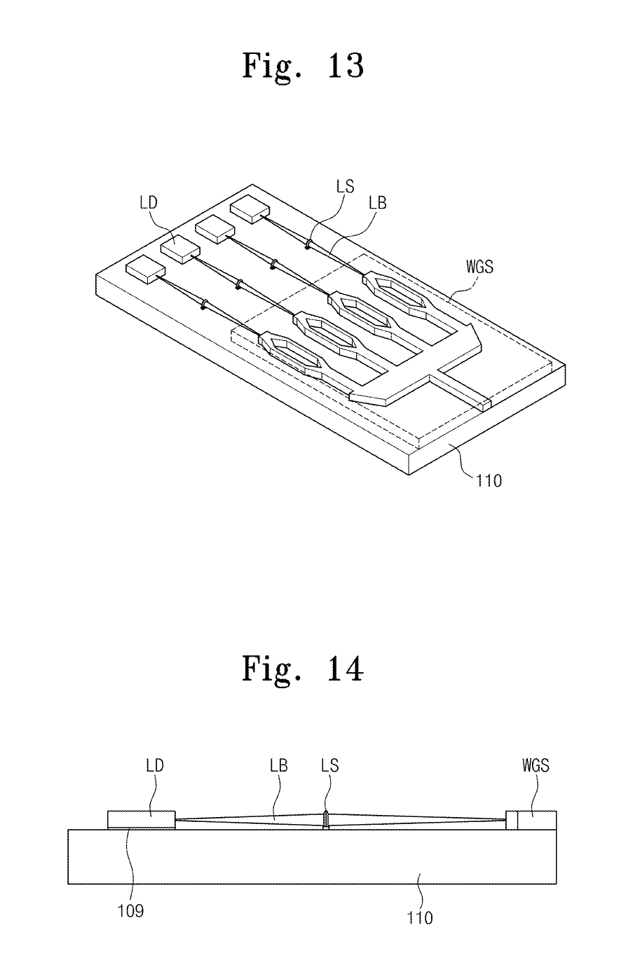

FIGS. 13 and 14 are a perspective view and a cross-sectional view illustrating a silicon photonics chip according to an embodiment of the present invention. The same parts of the current embodiment as those of the embodiments described with reference to FIGS. 1 through 12 may be omitted.

Referring to FIGS. 13 and 14, the light emitting devices LD may be disposed on the silicon substrate 110 through adhesive, or using a flip-chip bonding technology or wafer bonding technology. A laser beam LB emitted from the light emitting device LD, that is, the incident light may be incident through free space to an optical waveguide structure WGS extended to the photoelectric devices. According to embodiments of the present invention, as illustrated in FIGS. 13 and 14, one or more micro lenses LS may be disposed between the light emitting devices LD and the optical waveguide structure WGS to guide the laser beam LB to the optical waveguide structure WGS. According to the current embodiment, the space between the light emitting devices LD and the optical waveguide structure WGS may be filled with material having refractivity less than that of the silicon substrate 110.

Like the embodiment of FIG. 12, a thermal control member 109 may be disposed between the light emitting device LD and the silicon substrate 110 to thermally separate the light emitting device LD from the silicon substrate 110. For example, the thermal control member 109 may be heat insulating adhesive, a cooling member having high heat conductivity, or a Peltier element.

According to the embodiments of the present invention, the efficiency, durability, and stability in optically connecting the silicon photonics chip to the light emitting device can be improved. Moreover, the efficiency, durability, and stability in physically connecting the silicon photonics chip to the light emitting device can be improved. In addition, the packaged silicon photonics device includes the passivation member covering the silicon photonics chip, so that the durability and stability in the optical or physical connection can be further improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A silicon photonics chip comprising photoelectric devices integrated on a silicon substrate,
wherein the photoelectric devices include an optical connection device optically guiding at least one signal light incident from a signal light generation device to transmit the signal light onto the silicon substrate, and
the signal light generation device is thermally separated from the photoelectric devices, and is optically connected to the photoelectric devices.

2. The silicon photonics chip of claim 1, further comprising an internal ferrule including at least one internal optical fiber and optically aligned with the optical connection device,
wherein the internal ferrule is optically aligned with an external ferrule guiding the signal light incident from the signal light generation device.

3. The silicon photonics chip of claim 2, wherein the external ferrule comprises at least one external optical fiber and an external engagement element, the external optical fiber being configured to provide an optical connection passage between the signal light generation device and the silicon photonics chip and the external engagement element being configured to provide a physically connection with the internal ferrule, and
the internal ferrule comprises an internal engagement element being configured to be physically engaged with the external engagement element, such that the internal optical fiber can be optically aligned with the external optical fiber.

4. The silicon photonics chip of claim 2, wherein the internal ferrule forms a slanted angle ranging from about 1° to about 20° with a normal line to an upper surface of the silicon substrate.

5. The silicon photonics chip of claim 2, wherein the internal optical fiber is a core expansion optical fiber.

6. The silicon photonics chip of claim 2, wherein the internal optical fiber is a lensed fiber.

7. The silicon photonics chip of claim 1, wherein the optical connection device comprises a grating coupler disposed on the silicon substrate.

8. The silicon photonics chip of claim 1, wherein the silicon substrate comprises a silicon pattern defining a groove region, and a waveguide disposed in the groove region and extending to one of the photoelectric devices,
the silicon pattern comprises a side wall slanted from an upper surface of the silicon substrate, and
the slanted side wall of the silicon pattern is used as the optical connection device guiding the signal light to the waveguide.

9. The silicon photonics chip of claim 1, further comprising a thermal control member thermally separating the signal light generation device from the photoelectric devices,
wherein the silicon substrate comprises a groove region, and the signal light generation device is disposed in the groove region.

10. The silicon photonics chip of claim 9, further comprising a waveguide disposed on the silicon substrate and extending to one of the photoelectric devices,
wherein the waveguide has an endportion adjacent to the signal light generation device that is configured to guide the signal light to one of the photoelectric devices.

11. The silicon photonics chip of claim 1, wherein the photoelectric devices comprises a modulator, a multiplexer (MUX), and a demultiplexer (DEMUX), and a light receiving device, and
the modulator is configured to vary an optical characteristic of at least one signal light incident from the optical connection device using an electrical method.

12. The silicon photonics chip of claim 1, further comprising an internal ferrule including at least one internal optical fiber and optically aligned with the optical connection device,
wherein the signal light generation device is packaged on the internal ferrule through a flexible printed circuit board including conductive interconnections, and is optically aligned with the internal optical fiber.

13. The silicon photonics chip of claim 1, further comprising:
a printed circuit board under the silicon substrate to be electrically connected to the photoelectric devices; and
a passivation member on the silicon substrate to cover the photoelectric devices and expose an internal ferrule,
wherein the passivation member is adhered to a side wall of the internal ferrule using an adhesive member and fixed to the printed circuit board using a fixing member.

14. The silicon photonics chip of claim 13, wherein an upper surface of the passivation member is higher than an upper surface of the internal ferrule.

15. The silicon photonics chip of claim 1, wherein the signal light generation device is attached onto the silicon substrate, and
a thermal control member is further disposed between the signal light generation device and the silicon substrate.

16. The silicon photonics chip of claim 15, wherein the optical connection device comprises a microlens disposed between the signal light generation device and the photoelectric devices.
